(19) United States
(12) Patent Application Publication
(10) Pub. No.: US 2017/0247609 A1
(43) Pub. Date: Aug. 31, 2017

(54) METHODS AND COMPOSITIONS FOR RECOVERY OF RESIDUAL OIL FROM A POROUS STRUCTURE

(71) Applicant: Board of Regents, The University of Texas System, Austin, TX (US)

(72) Inventors: Hugh Daigle, Austin, TX (US); Chun Huh, Austin, TX (US); Yusra Khan Ahmad, Webster, TX (US)

(21) Appl. No.: 15/444,817

(22) Filed: Feb. 28, 2017

Related U.S. Application Data
(60) Provisional application No. 62/301,070, filed on Feb. 29, 2016.

(51) Int. Cl. C09K 8/92; E21B 43/20; C09K 8/86

(52) U.S. Cl. CPC C09K 8/92; C09K 8/86; E21B 43/20; C09K 2208/10

(57) ABSTRACT

The methods disclosed herein allow for the recovery of at least 55% of residual heavy oil from porous structures. In the disclosed methods, porous structures are contacted with emulsions having an aqueous continuous phase and an organic dispersed phase. The organic dispersed phase includes organic compounds having five or fewer carbon atoms (such as natural gas), which are typically difficult to emulsify because they are unstable at ambient conditions. To solve that problem, the emulsions disclosed herein are stabilized by nanoparticles having hydrophilic exterior surfaces. The nanoparticles make up at least 0.1% of the emulsion by weight. The use of hydrophilic nanoparticles as stabilizers combines the utility of natural gas liquids in enhanced oil recovery (due to their high solubility in residual oil and attendant viscosity reduction) with the utility of emulsions (delivery of viscosity-reducing agents along with an immiscible phase to push out the trapped oil).

### CROSS REFERENCE TO RELATED APPLICATIONS

This application claims the benefit of priority to U.S. Provisional Application No. 62/301,070, filed Feb. 29, 2016, which is incorporated by reference herein in its entirety.

### FIELD

The methods and compositions disclosed herein pertain to the field of oil recovery, particularly the recovery of heavy oil.

### BACKGROUND

Conventional oil-in-water emulsions used in the oil and gas industry have been stabilized by surfactants or colloidal particles. Nanoparticle-stabilized emulsions have received increasing attention because of their potentially useful properties for oil recovery purposes. Some unique properties that nanoparticle-stabilized emulsions possess over their conventional counterparts are improved conformance control and increased sweep efficiencies, due to larger apparent viscosities as a result of droplet-droplet interactions. While colloidal particles >100 nm in diameter may plug pore throats and be retained in porous media, nanoparticles are small enough to pass through these pores. However, one of the major challenges faced when considering the use of emulsions are the harsh reservoir conditions such as high salinity, pressure, and temperature, which often destabilize conventional emulsions. Because of the nature of the nanoparticles (being a solid object), it is thought that these harsh conditions will have less of an effect on destabilizing these types of emulsions.

Some of the nanoparticles used to stabilize oil-in-water emulsions are spherical and can be made of silica, with diameters ranging in the tens of nanometers. The wettability of the nanoparticles can be controlled by various surface modifications.

Due to the increased interest in nanoparticle-stabilized emulsions, many studies have been done on emulsion characterization. These include degree of stability, droplet size, bulk viscosity, and interfacial properties. A variety of studies have been conducted on the numerous factors characterizing emulsion behavior. Research has been conducted on the effects of nanoparticle size, wettability, and concentration, ionic strength of the aqueous phase, pH, and oil type (Binks, B. P., et al., 2000, “Effect of Oil Type and Aqueous Phase Composition On Oil-Water Mixtures Containing Particles of Intermediate Hydrophobicity”, Phys Chem Chem Phys, 2(13):2959-2967; Binks, B. P., et al., 2000, “Influence of Particle Wettability on the Type and Stability of Surfactant-Free Emulsions”, Langmuir, 16(23):8622-8631; Binks, B. P., et al., 2005, “Inversion of Silica-Stabilized Emulsions Induced by Particle Concentration”, Langmuir, 21(8):3296-3302; Binks, B. P., et al., 2005, “Inversion of Emulsions Stabilized Solely by Ionizable Nanoparticles”, Angew Chem, 117(3):445-448; Horozov, T. S., et al., 2007, “Effect of Electrolyte in Silicone Oil-in-Water Emulsions Stabilized by Fumed Silica Particles”, Phys Chem Chem Phys, 9(48):6398-6404; Hunter, T. N., et al., 2008, “The Role of Particles in Stabilizing Foams and Emulsions”, Adv Colloid Interface Sci, 137(2):57-81).

Multiple theoretical models have been developed for the equilibrium of emulsions stabilized by solid particles (Levine, S., et al., 1991, “Capillary Interaction of Spherical Particles Adsorbed on the Surface of an Oil/Water Droplet Stabilized by the Particles. Part I”, Colloids & Surf, 59(8):377-386; Levine, S., et al., 1992, “Capillary Interaction of Spherical Particles Adsorbed on the Surface of an Oil/Water Droplet Stabilized by the Particles. Part II”, Colloids & Surf, 65(4):273-286; Levine, S., et al., 1993, “Capillary Interaction of Spherical Particles Adsorbed on the Surface of an Oil/Water Droplet Stabilized by the Particles. Part III”, Colloids & Surf A: Physicochem. Eng. Aspects, 70(1):33-45; Kralchevsky, et al., 2005, “On the Thermodynamics of Particle-Stabilized Emulsions: Curvature Effects and Catastrophic Phase Inversion”, Langmuir, 21(1):50-63; Reincke, F., et al., 2006, “Understanding the Self-Assembly of Charged Nanoparticles at the Water/oil Interface”, Phys Chem Chem Phys, 8(33):3828-3835). In addition to inter-droplet stability, the nanoparticles attached at the oil-water interfaces must achieve inter-particle equilibrium based on the balance of electrostatic repulsions, van der Waals attractions, and capillary forces (Horozov, et al., 2007, Id.; Bresme, F., et al., 2007, “Nanoparticles at Fluid Interfaces”, J Phys-Condensed Matter, 19, 41).

Horozov et al. (2007) investigated the effects of pH and electrolyte concentration on overall emulsion stability and rheological properties. The critical flocculation concentration was defined as the electrolyte concentration at which there was a significant increase in the turbidity and acceleration of sedimentation of the suspension. As the electrolyte concentration increased, the once electrostatically repulsed nanoparticles (negatively-charged) began to aggregate due to the addition of positively-charged ions. Emulsions generated using nanoparticle dispersions with higher electrolyte concentrations were shown to possess higher apparent viscosities and greater stability, i.e., greater resistance to creaming. This was contributed to the aggregation of nanoparticles in the dispersion phase, leading to a formation of a three-dimensional network of interconnected droplets and aggregates.

Both Zhang et al. (2010, “Nanoparticle-Stabilized Emulsions for Applications in Enhanced Oil Recovery”, SPE Improved Oil Recovery Symposium, SPE-129885-MS) and Gabel (“Generation, Stability, and Transport of Nanoparticle-Stabilized Oil-in-Water Emulsion in Porous Media,” M.S.E. Thesis, The University of Texas at Austin, Austin, Tex. (May 2014)) observed that silica nanoparticle-stabilized oil-in-water emulsions were highly shear-thinning power-law fluids. As the shear rate increases, the apparent viscosity of the emulsion decreases. Gabel showed that the apparent viscosity was independent of the nature of the oil phase, but rather highly dependent on emulsion droplet size—with increasing apparent viscosity as droplet size decreased. Pei et al. (2015 “Investigation of Synergy Between Nanoparticle and Surfactant in Stabilizing Oil-in-Water Emulsions for Improved Heavy Oil Recovery”, Colloids & Surf A: Physiochem Eng Aspects, 484(1):478-484) showed an increase in emulsion stability and residual heavy oil recovery effectiveness through the addition of nanoparticles to previously surfactant-stabilized emulsions. In this study of the synergistic effects of using both surfactants and nanoparticles to stabilize oil-in-water emulsions, micromodel tests were conducted that indicated more desirable mobility due to increases in emulsion viscosity resulting from the addition of nanoparticles. Compared to waterflooding and pure surfactant emulsions, the addition of nanoparticles greatly decreased viscous fingering phenomena, improving micromodel sweep efficiencies. Zhang et al. (2010) also hypothesized that the apparent viscosity could be dependent on the extent of droplet surface coverage with particles and the average distance between droplets. Inter-droplet force models have also been developed that show dependence on droplet shape (Brujie, J., et al., 2003, “Measuring the Distribution of Interdroplet Forces in a Compressed Emulsion System”, Physica A, 327:201-212).

Despite these advances, it remains difficult to recover residual heavy oils from formations. Currently the efficiency of recovery from heavy-oil-bearing formations is from 10-30%. Water flooding methods that work for lighter oils are often not sufficient for heavier oils. Carbon dioxide flooding can be helpful, but carbon dioxide can be difficult to obtain in certain situations. Surfactants that may work for lighter oils or for heavy oils under atmospheric conditions often degrade or are otherwise ineffective when placed in harsh downhole conditions. Though low weight natural gas compounds are highly soluble in higher weight hydrocarbons and thus show some promise for assisting in their recovery, natural gases are typically either gases or low-vapor-pressure liquids under atmospheric conditions, and thus they are usually not used for enhanced oil recovery. There remains a need for emulsions that efficiently recover residual heavy oils from formations. The compositions and methods disclosed herein address these and other needs.

### SUMMARY

In accordance with the purposes of the disclosed compositions and methods, as embodied and broadly described herein, the disclosed subject matter relates to compositions and methods of making and using the compositions. More specifically, according to the aspects illustrated herein, there are provided compositions and methods for recovery of residual oil from a porous structure. In the disclosed methods, porous structures (such as oil formations) are contacted with emulsions having an aqueous continuous phase and an organic dispersed phase. The organic dispersed phase includes organic compounds having five or fewer carbon atoms (such as natural gas). These compounds can assist in oil recovery due to their high solubility in residual oil and attendant viscosity reduction. However, they are typically difficult to emulsify because they are unstable at ambient conditions. To solve that problem, the emulsions disclosed herein are stabilized by nanoparticles having hydrophilic exterior surfaces. The use of hydrophilic nanoparticles as stabilizers combines the utility of natural gas liquids in enhanced oil recovery with the utility of emulsions (delivery of viscosity-reducing agents along with an immiscible phase to push out the trapped oil). The methods disclosed herein can allow for the recovery of at least 55% of residual heavy oil from porous structures.

In the emulsions disclosed herein, the nanoparticles make up at least 0.1% of the emulsion by weight. In some embodiments, the organic dispersed phase comprises pentane or butane. The apparent viscosity of the emulsion is less than or equal to 1 centipoise. The volume ratio of the aqueous phase to organic phase is from 0.5:1 to 4:1. In some embodiments, the volume ratio of the aqueous phase to the organic phase is 2:1. In these embodiments, the nanoparticles can make up at least 0.25% by weight of the total emulsion. When the 2:1 ratio emulsion comprises pentane, the nanoparticles can make up about 0.32% by weight of the total emulsion. When the 2:1 ratio emulsion comprises butane, the nanoparticles can make up about 0.3% by weight of the total emulsion. In other embodiments, the volume ratio of the aqueous phase to the organic phase is 1:1. In these embodiments, the nanoparticles can make up at least 0.12% by weight of the total emulsion. When the 2:1 ratio emulsion comprises pentane, the nanoparticles can make up about 0.16% by weight of the total emulsion. When the 2:1 ratio emulsion comprises butane, the nanoparticles can make up about 0.15% by weight of the total emulsion. The dispersed organic phase comprises droplets ranging from 20 to 100 micrometers in diameter.

The nanoparticles measure from 5 to 25 nanometers across at their widest point. No surfactants are included in the emulsions. The nanoparticles can include a hydrophilic coating. In some embodiments, nanoparticles can include a PEG coating. In some embodiments, the nanoparticles are silica nanoparticles.

The aqueous phase of the emulsion can be salinated water or seawater. In some embodiments, the water is from 3 to 20% NaCl by weight. CaCl₂ can be included at a 4:1 ratio of NaCl to CaCl₂, for example. In some particular embodiments, the water is 3% NaCl by weight.

The method of recovering residual heavy oil from a porous structure can include recovering at least 55% of the residual oil. The porous structure can be a formation. In some embodiments, the amount of residual heavy oil recovered can be at least 65%. In other embodiments, the amount recovered can be at least 80%. The method can further include moving the emulsion through the porous structure at flow rates less than or equal to 12 mL/min, 4 mL/min, or 1 mL/min.

Some implementations of the method include moving a slug of the emulsion through the porous structure as opposed to a continuous flow of the emulsion. In some embodiments, a 0.75 PV (or smaller) slug is moved through the porous structure (meaning that the ratio of the volume of the emulsion moved through the porous structure to the pore volume, PV, of the porous structure is 0.75 or less). In other implementations, the slug can be 0.5 PV or less. Some implementations can include flushing the porous structure with water after contacting the porous structure with the emulsion. The water can be salinated water or seawater. Some implementations of the method include a step of collecting seawater. The seawater can be used as part of the aqueous phase of the emulsion, or can be used to flush the porous structure after contacting it with the emulsion. In some implementations of the method, the emulsion is maintained at a pressure of at least 100 PSI.

Additional advantages will be set forth in part in the description that follows or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE FIGURES

The accompanying figures, which are incorporated in and constitute a part of this specification, illustrate several aspects described below.

FIG. 1 is an experimental schematic for butane emulsion generation.

FIG. 2 shows the sample effluent of brine displacement by light mineral oil to reach residual water saturation.

FIG. 3 shows the sample effluent of Texaco oil displacement by brine to reach residual oil saturation. The shaded rectangles around the centrifugal tubes suggest an increase in brine injection flow rate.

FIG. 4 is a graph showing the transient examination of NYACOL DP9711™ nanoparticle dispersion at 2 wt % and 20 wt % API brine.

FIG. 5 shows the results of an in depth examination of the effects of salinity on effective nanoparticle size for NYACOL DP9711™ nanoparticle dispersion at 2 wt %. NYACOL DP9711™ at 20 wt % API was unstable transiently. Initial size at time of preparation given.

FIG. 6 shows droplet images for pentane-in-water emulsions with varied nanoparticle phase and salinity. The images in the first column are at 20× magnification (200 μm scale bar) while the rest are at 40× magnification (50 μm scale bar).

FIG. 7 is a group of graphs of the emulsion droplet size distributions for varying API brine wt % using the NYACOL DP9711™ nanoparticle dispersion.

FIG. 8 is a group of graphs of the emulsion droplet size distributions for varying API brine wt % using the PEG-coated nanoparticle dispersion.

FIG. 9 is a graph showing the median droplet size for varying API brine wt %'s using the NYACOL DP9711™ nanoparticle dispersion.

FIG. 10 is a graph showing the median droplet size for varying API brine wt %'s using the PEG-coated nanoparticle dispersion.

FIG. 11 is a graph showing the rheology results for emulsions made with NYACOL DP9711™ nanoparticle dispersion at varying salinities.

FIG. 12 is a graph showing the rheology results for emulsions made with PEG-coated nanoparticle dispersion at varying salinities.

FIG. 13 shows butane emulsions generated at varying salinities using NYACOL DP9711™ dispersion. The black dashed lines distinguish the emulsion phase. Above the top black dashed line: liquid n-butane phase. Below the bottom black dashed line: nanoparticle dispersion phase.

FIG. 14 shows the recovery of light mineral oil (dyed pink) by pentane-in-water emulsion stabilized with NYACOL DP9711™ nanoparticles dispersed in brine, when the experiment is performed at 4 mL/min. The injected pentane was colorless. The amount of recovered oil can be assessed by the lightness of the pink shade as well as when the effluent reaches steady state. “Effluent Collected at Time 0” refers to the state of the effluent collected during the coreflood. “Effluent at Steady-State” refers to the state of the effluent once no change was observed in volume due to the evaporation of pentane.

FIG. 15 shows the recovery of light mineral oil (dyed red) by pentane-in-water emulsion stabilized with NYACOL DP9711™ nanoparticles dispersed in brine when the experiment is performed at 1 mL/min. The injected pentane was colorless. The amount of recovered oil can be assessed by the lightness of the red shade as well as when the effluent reaches steady state. “Effluent Collected at Time 0” refers to the state of the effluent collected during the coreflood. “Effluent at Steady-State” refers to the state of the effluent once no change was observed in volume due to the evaporation of pentane.

FIG. 16 shows the recovery of light mineral oil (dyed red) by a 0.50 PV slug of pentane-in-water emulsion stabilized with NYACOL DP9711™ nanoparticles dispersed in brine, followed by a post-brine flush. The experiment was performed at 4 mL/min. The injected pentane was colorless. The amount of recovered oil can be assessed by the lightness of the red shade as well as when the effluent reaches steady state. “Effluent Collected at Time 0” refers to the state of the effluent collected during the coreflood. “Effluent at Steady-State” refers to the state of the effluent once no change was observed in volume due to the evaporation of pentane. The discontinuity in the measurements is due to the switching of pumps.

FIG. 17 shows the recovery of light mineral oil (dyed red) by 0.50 PV slug of pentane-in-water emulsion stabilized with NYACOL DP9711™ nanoparticles dispersed in brine, followed by a post-brine flush. The experiment was performed at 1 mL/min. The injected pentane was colorless. The amount of recovered oil can be assessed by the lightness of the red shade as well as when the effluent reaches steady state. “Effluent Collected at Time 0” refers to the state of the effluent collected during the coreflood. “Effluent at Steady-State” refers to the state of the effluent once no change was observed in volume due to the evaporation of pentane.

### DETAILED DESCRIPTION

The methods and compositions described herein may be understood more readily by reference to the following detailed description of specific aspects of the disclosed subject matter and the Examples and Figures included therein.

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings:

As used in the specification and the appended claims, the singular forms “a,” “an” and “the” include plural referents unless the context clearly dictates otherwise. Ranges may be expressed herein as from one particular value, and/or to another particular value. When such a range is expressed, another embodiment includes from the one particular value and/or to the other particular value. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

As used herein, a “porous structure” means any structure having pores, wherein the pores are capable of being flooded by heavy oil, natural gas liquids, and/or water. For example, a porous structure could be an actual oil formation, or a Boise sandstone core used for research purposes.

As used herein, “heavy oil” means liquid hydrocarbon having a specific gravity greater than or equal to 0.934 at 60° F.

As used herein, “hydrophilic” means having a tendency to mix with, dissolve in, or be wetted by water. The nanoparticles described herein can be considered hydrophilic if the contact angle of water on the nanoparticle surface is less than 90°.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The methods disclosed herein can allow for the recovery of 55% or more of residual heavy oil from porous structures. In the disclosed methods, porous structures are contacted with emulsions having an aqueous continuous phase and an organic dispersed phase. The organic dispersed phase includes organic compounds having five or fewer carbon atoms (such as natural gas, butane, and pentane), which are typically difficult to emulsify because they are unstable at ambient conditions. To solve that problem, the emulsions disclosed herein are stabilized by nanoparticles with hydrophilic exterior surfaces. The nanoparticles can make up at least 0.1% of the emulsion by weight.

The use of hydrophilic nanoparticles as stabilizers combines the utility of natural gas liquids in enhanced oil recovery (due to their high solubility in residual oil and attendant viscosity reduction) with the utility of emulsions (delivery of viscosity-reducing agents along with an immiscible phase to push out the trapped oil). Unlike surfactants, hydrophilic nanoparticles stabilize these in the subsurface over wide ranges of pH and temperature. Furthermore, natural gas liquids are often considered a waste product in oil production because they are very inexpensive in domestic markets. However, the low cost is an advantage for their use in enhanced oil recovery, and could create a market for an underutilized resource. In some cases, natural gas could even be collected at the well site, mixed with water and nanoparticles, and used at the same location. For offshore well sites, the water used could be seawater.

The viscosity is affected by the volume ratio of the aqueous phase to the organic phase. This ratio can be from 0.5:1 to 4:1. In some embodiments, the volume ratio of the aqueous phase to the organic phase is 2:1. In other embodiments, the volume ratio of the aqueous phase to the organic phase is 1:1. Because the low weight organic compounds are still somewhat volatile despite the presence of the nanoparticles, the emulsions can be stored under pressure to lengthen the time that the emulsion remains stable. In some embodiments, the storage pressure can be 100 PSI or greater.

The organic compound included in the organic dispersed phase can be any organic compound with five or fewer carbon atoms. For example, the organic compounds included in natural gas include n-pentane, i-pentane, neo-pentane, n-butane, i-butane, propane, ethane, and methane. The organic dispersed phase can include a single type of compound, or could include a mixture of compounds having five or fewer carbon atoms. In one embodiment, the organic dispersed phase comprises butane. In another embodiment, the organic dispersed phase comprises pentane. The droplets of the organic dispersed phase can be from 20 to 100 μm in diameter. For example, the droplets can be from 20 to 100, from 20 to 80, from 20 to 60, from 20 to 40, from 40 to 100, from 40 to 80, from 40 to 60, from 60 to 100, from 60 to 80, or from 80 to 100 um.

The water of the aqueous continuous phase of the emulsion can, in some embodiments, be salinated. The salination may be natural; for example, seawater can be used as the water in the aqueous continuous phase of the emulsion. In other embodiments, sodium chloride (NaCl) can be added to the water. The NaCl concentration can be from 3 to 20% by weight, for example, 3, 4, 5, 6, 7, 8, 9, 10, 11, 12, 13, 14, 15, 16, 17, 18, 19, or 20% by weight, where any of the stated values can form an upper or lower endpoint of a range. In some particular embodiments, the NaCl concentration can be 3%. In some embodiments, the salinated water can fit the definitions of American Petroleum Institute (API) brine. In some embodiments, calcium chloride (CaCl₂) can be included in the aqueous phase with the sodium chloride. The ratio of NaCl to CaCl₂ is 4:1 in some embodiments.

The nanoparticles are used to stabilize the emulsion. Stabilizing the emulsion means preventing the coalescence of the dispersed phase. In some embodiments, the nanoparticles are mixed into the aqueous phase at least 2% by weight prior to mixing with the organic phase. For example, the aqueous phase can contain 2, 4, 6, 8, 10, 12, 14, 16, 18, 20, 22, 24, 26, 28, or 30% nanoparticles by weight, where any of the stated values can form an upper or lower endpoint of a range. After mixing, the nanoparticles make up at least 0.25% by weight of a total emulsion having a 2:1 volume ratio of aqueous:dispersed phase. In emulsions having a 2:1 volume ratio of aqueous phase:pentane, the nanoparticles make up 0.32% by weight of the total emulsion. In emulsions having a 2:1 volume ratio of aqueous phase:butane, the nanoparticles make up 0.3% by weight of the total emulsion. For emulsions having a 1:1 volume ratio of aqueous:dispersed phase, the nanoparticles make up at least 0.1% by weight of the total emulsion. In emulsions having a 1:1 volume ratio of aqueous phase:pentane, the nanoparticles make up 0.16% by weight of the total emulsion. In emulsions having a 1:1 volume ratio of aqueous phase:butane, the nanoparticles make up 0.15% by weight of the total emulsion.

As used herein, nanoparticles are defined as small particles measuring from 1 to 100 nanometers across at their widest point. In some embodiments described herein, the nanoparticles measure from 5 to 25 nanometers across at their widest point. However, other sizes of nanoparticles could potentially be used to stabilize the emulsion. For example, nanoparticle sizes could range from 1 to 90, from 1 to 80, from 1 to 70, from 1 to 60, from 1 to 50, from 1 to 40, from 1 to 30, from 1 to 20, from 1 to 10 nanometers across at their widest point.

The nanoparticles used in the described embodiments have a hydrophilic exterior surface. In some embodiments, the entire nanoparticle can be hydrophilic. Other embodiments can comprise a hydrophilic coating on the exterior surface of the nanoparticle. In some embodiments, the nanoparticles comprise a PEG coating. In some embodiments, the nanoparticles are silica nanoparticles.

The methods of using the emulsions include recovering 55% or more of the residual oil from a porous structure. The residual oil is heavy oil, or oil having a specific gravity of 0.934 or greater at 60° F. The porous structure can, in some embodiments, be a formation containing the oil. As used herein, “formation” describes a subsurface structure containing oil. Some embodiments of the method can recover greater than 65% of the heavy oil from the porous structure, and some embodiments can recover greater than 80% of the heavy oil from the porous structure. The methods can also be used to recover lighter oils having specific gravities lower than 0.934 from porous structures. For example, the methods can be used to recover mineral oil having a specific gravity of from 0.85 or more at 60° F. Mineral oil is an accepted representative of heavy oil for laboratory experimentation purposes.

The methods can include moving the emulsion through the porous structure. In some embodiments, the emulsion is moved through the porous structure at a rate equal to or less than 12 mL/min. In other embodiments, the emulsion is moved through the porous structure at 4 mL/min, or at 1 mL/min. Instead of continuously moving the emulsion through the porous structure, the method could alternatively include moving a slug of the emulsion through the porous structure. As used herein, a slug is defined as a particular volume of emulsion. In some embodiments, the ratio of the slug volume to the pore volume of the porous structure is 0.75 or less (≦0.75 PV). In other embodiments, the ratio of the slug volume to the pore volume of the porous structure is 0.5 or less (≦0.5 PV). The slug can be followed by a post-brine flush. In a post-brine flush, the porous structure is flushed with water after contacting the porous structure with the emulsion. In some embodiments, the water is salinated water or seawater. The seawater can be collected as part of the method, to be used as part of the post-brine flush, as part of the aqueous phase of the emulsion, or both.

The following Examples detail the study of the effects of salinity on the stability of two nanoparticle dispersions. The droplet size, stability, and rheology of pentane and water emulsions found to be affected by the salinity of the aqueous phase. Liquid butane emulsions of varying salinity were generated as well to assess the effects of salinity on the stability of these emulsions. Coreflooding experiments using pentane emulsions where then conducted to investigate the efficacy of using the disclosed emulsions for residual oil recovery.

### Examples

The following examples are set forth below to illustrate the methods and results according to the disclosed subject matter. These examples are not intended to be inclusive of all aspects of the subject matter disclosed herein, but rather to illustrate representative methods, compositions, and results. These examples are not intended to exclude equivalents and variations of the present invention, which are apparent to one skilled in the art.

Sandstone Core: The majority of the experiments were performed using Boise sandstone cores. Boise sandstones are readily available, have low clay content, are relatively low in heterogeneity and have reasonable permeabilities where emulsion flow is a viable, practical application. All Boise sandstone cores used were 30.48 cm in length and 2.54 cm in diameter. Typical pore volumes were in the 40-45 mL range with porosities seen in the 0.25-0.30 range.

Nanoparticle Stabilized Emulsions: Various emulsions were used for injection into Boise sandstone cores under different experimental conditions. All emulsions injected were generated by co-injection through a beadpack filled with 180 micron glass beads. Two types of partially hydrophilic silica nanoparticles were used in the experiments. NYACOL DP9711™, from Nyacol Nano Technologies, is an aqueous dispersion of partially hydrophilic nanoparticles (30 wt %) with a nominal particle size of 20 nm. The pH of the DP9711 dispersion is 3. The second nanoparticle dispersion contained partially hydrophilic, polyethylene glycol (PEG)-coated nanoparticles (18.1 wt %) with a measured particle size of 13 nm. Its pH is 9.65.

Organic and Aqueous Phases: Reagent grade n-butane and pentane were used for the oil phase in the emulsions, while Fisherbrand light mineral oil was used as the residual oil phase for the coreflood experiments. The bulk viscosity of pentane is 0.24 centipoise. Deionized water was used to dilute the nanoparticle dispersions. Reagent grade sodium chloride and calcium chloride were used to create American Petroleum Institute (API) standard brine. API brine contains a 4:1 ratio of sodium chloride to calcium chloride by mass. For Examples 1-6, NYACOL DP9711™ nanoparticles were used as part of the aqueous phase, prepared in dispersions of varying salinity. The first dispersion contained 2 wt % nanoparticles and 3 wt % NaCl prepared in DI water. Four other dispersions were created with constant nanoparticle concentrations (2 wt %) and varying API brine salinities at 5 wt %, 10 wt %, 15 wt %, and 20 wt % in DI water. For Examples 7-10, 3 wt % NaCl brine was used as the continuous phase of the emulsions generated. 2 wt % NaCl brine was used to initially saturate the core in order to measure the permeability of the Boise sandstone.

Effluent Test Tube: Plastic centrifugal tubes were used to collect the effluent generated from the coreflood experiments. Each test tube had the capacity to collect about 15 mL of effluent but in most experiments about 12 mL of effluent was collected per tube. 12 mL amounted to approximately 0.25-0.30 pore volumes depending on the specific Boise sandstone core. A typical sample of coreflood effluent contained an excess organic phase on the top, emulsion, if any, in the middle and the aqueous nanoparticle dispersion at the bottom. All effluent test tubes were placed in a fraction collector with an appropriate time setting dependent on the injection rate.

Core Holder: A Hassler type core holder was used for all of the examples. This core holder was manufactured by Phoenix Instruments Inc. and is designed to hold cores cut to 2.54 cm in diameter and 30.48 cm length. The confining pressure of the core holder was set to 2000 psi with a working temperature of 156° C. A Viton sleeve was present inside the core holder for better placement of the core as well as for efficient confining. Confining the sandstone core is important to allow all injected fluids to enter the core rather than flow around it. Metal framing by Unistrut was used to mount the core holder vertically for all experiments performed. The core holder has 5 equally spaced pressure taps to enable the measurement of pressure drop across specific sections of the sandstone core. These taps were not used for the majority of the experiments.

Pressure Transducers and Data Acquisition: Three Rosemount differential pressure transducers were used to monitor pressure changes across the core for the entirety of the coreflood experiments. The differential pressure transducers were connected to a data acquisition card, powered by a power supply unit, which allowed the collection of all pressure points and recorded them into the computer. LabView software was used to display and record the collected pressure data. The pressure data was corrected for any offset from zero pressure drop if seen. Although the Rosemount differential pressure transducers had a maximum working pressure of 2,000 psi, the three transducers were calibrated to a specific pressure range to provide most accuracy within that range.

Procedure to Measure Effective Nanoparticle Size: The effective size of the nanoparticles was measured using the Malvern Dynamic Light Scattering Zetasizer Nano ZS. The effective particle size was determined for varying API brine concentrations while the nanoparticle concentration was held constant at 2 wt %. The API brine concentration for the NYACOL DP9711™ dispersions was varied from 0-20 wt % in increments of 2 wt %. Effective nanoparticle size distributions were determined for these dispersions within one hour of initial preparation. A transient analysis of the effective particle size distributions of the NYACOL DP9711™ dispersions was made over the course of two days for salinities varying from 0-20 wt % in increments of 5 wt %. A transient analysis of effective particle size for dispersions containing PEG-coated nanoparticles was conducted for salinities ranging from 0-20 wt % in increments of 5 wt % over the span of two days.

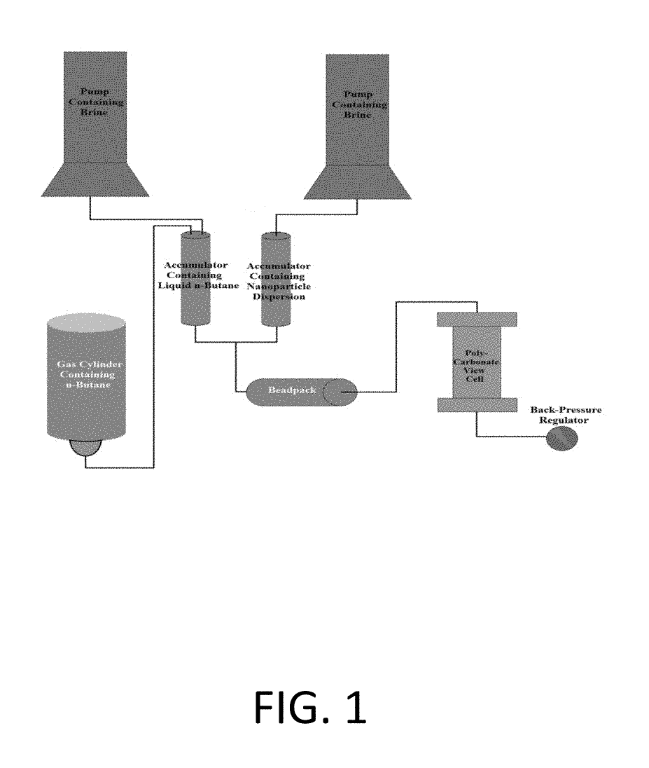

Procedure to Make Pentane and Butane Emulsions: A general overview of the experimental set-up is seen in FIG. 1. Pentane and nanoparticle dispersion were co-injected at a 1:1 volume ratio into a high pressure column filled with 180 μm hydrophilic glass beads (beadpack). The flow through the glass beads provided the shearing forces needed to create emulsion in the effluent. Flow of each phase was held constant at 12 mL/min from two Teledyne ISCO syringe pumps. To prevent the nanoparticles from directly contacting the elements of the pump, an accumulator was used. One of the pumps was filled with pentane, while the other was filled with DI water used to drive the nanoparticle phase in the accumulator. Pentane emulsions were collected in a series of graded tubes from the effluent of the beadpack (view cell and backpressure regulator were disconnected). For emulsion stability tests, changes in emulsion volume fraction with time were observed. Immediately after an emulsion was generated, viscosity vs. shear rate measurements were conducted using an AR-G2 rheometer from TA Instruments. Also, estimations of average droplet size were made using a Nikon Labohot-Pol microscope, Digital Sight DS-Fil camera, NIS-Elements imaging software, and ImageJ. For permeability measurements of the core, a similar setup was used where the injection fluid was brine. Similar setups were also used to waterflood the core, the only difference being the absence of the accumulator.

Because of the volatility of butane, a gas cylinder containing n-butane at 20 psi was inverted to maximize the amount of liquid butane that could be pulled from the cylinder. By inverting the cylinder, the denser liquid butane phase settled to the bottom, and flow from the cylinder was driven by the gas-phase on top (due to expansion). Two Teledyne ISCO syringe pumps were used to either hold a constant pressure in the system or supply a determined flow rate of brine, which acted as a power fluid for the accumulators. Two steel accumulators were used to drive the liquid n-butane and nanoparticle dispersion. The flow from each accumulator was co-injected into a beadpack filled with 180 μm hydrophilic glass beads. The effluent flow from the beadpack was collected in a custom-made polycarbonate view cell, which was connected to a back-pressure regulator calibrated to 100 psi.

Procedure for Residual Oil Recovery Corefloods. For the purposes of measuring the pore volume of the Boise sandstone, the dry weight of the core was recorded. Once the dry weight was recorded, the core was placed in a plastic container to be vacuumed overnight using a 1402 Welch Duoseal vacuum pump. After removing any trapped air in the core by vacuuming the core for approximately 24 hours, the dry core was then saturated with brine for approximately 2-3 hours. Finally the wet core was removed from the plastic sealed container and weighed again to get the wet weight of the core. The pore volume of the core was determined by simply subtracting the dry weight of the core from the wet weight of the core divided by the density of brine. The porosity of the cores used in these examples was determined to be 0.28. After the wet weight of the sandstone core had been measured, the brine-saturated core was loaded into the core holder.

Before opening the end caps of the core holder, care was taken to de-pressurize the core holder from the previous experiment. The core holder comprised two end caps. The top end cap was screwed into place using a steel screw piece whereas the bottom end cap was twisted to fit in place by hand. To place the sandstone core into place, both the end caps were removed. The previously used sandstone core was removed from the core holder using a steel rod which would push the core from the top end, to be collected at the bottom end. Before adding the new core to the core holder, the bottom end cap piece was flushed with brine to remove any presence of dead volume accumulated from previous experiments. After the bottom end cap was flushed clean, it was twisted by hand and locked into place. The core was then inserted from the top end, gently by hand. Once the core was inserted all the way, the top end cap was secured using the steel-screw piece. The core was then confined to a desired confining pressure. Confining pressure was applied to the core via a hand pump which pumped mechanical pump oil. A pressure gauge was monitored until the desired pressure of approximately 2000 psi was obtained. An Enerpac P-392 hydraulic hand pump was used to pump mechanical pump oil into the annulus of the core holder. This pump had the capacity to pump up to 10,000 psi.

After the sandstone core was placed and confined to 2000 psi in the core holder, it was necessary to measure the permeability of the core before any experiment can be performed. The permeability of the core was measured by injecting brine pumped by the ISCO syringe pump, into which it had been previously loaded. Brine was injected into the bottom of the core until a steady state pressure drop was recorded by the transducer. The pressure drop was measured by the differential pressure transducer and recorded via the LABView software. If there was a small offset in the baseline recorded pressure, this was corrected by recording the pressure at zero flow rate and adjusting all values recorded afterwards. After the permeability of the core was recorded, the initial saturation of the core was changed, depending on the specific organic phase required to be recovered for any given experiment. The desired oil was injected into the core until the effluent showed no sign of recovering any more water, i.e., residual water saturation, S_{wr}. Usually residual water saturation was reached by injection of approximately ten pore volumes of organic phase. Oil was injected from the top of the core, rather than the bottom, to provide a more gravity-stable, uniform displacement of denser brine by less dense organic phase. Because oil was being injected from the top, for this particular step of the experiment, it was essential to reverse the configuration of the differential pressure transducers. If the lines were not reversed, a negative value would be recorded for pressure.

The examples assess the percentage of residual oil recovered by injecting a specific nanoparticle-stabilized emulsion. Before this emulsion could be injected into the core, the sandstone core had to be waterflooded to reach residual oil saturation, Sₒᵣ. For this purpose, brine was injected through the bottom of the core to displace oil. Brine injection was initially performed at a low flow rate (˜2 mL/min). When no more oil was recovered at this low flow rate, the flow rate was increased to potentially displace small amounts of more oil. The flow rate was incrementally increased until no more oil was displaced by brine. Residual oil saturation was reached when after all incremental flow rates, only brine was collected in the effluent. Typical flow rates for the waterflooding procedure typically began at 4 mL/minute and were incrementally increased to 8 mL/minute, and finally 12 mL/minute.

Calculating Core Pore Volume: As explained herein, the core was weighed initially before vacuuming to measure the dry weight. After saturating the core with brine, it was weighed again to measure the wet weight of the core. The core pore volume, PV, was calculated using the following equation:

$$PV = \frac{{M}_{wet} - {M}_{dry}}{{ρ}_{brine}} , \qquad ( Eq . 1 )$$

where M_{wet} is the mass of the core after brine saturation (g), M_{dry} is the dry mass of the core (g), and ρ_{brine} is the density of the brine (g/mL). The pore volumes of the cores ranged from 40-45 mL for Boise sandstone, corresponding to porosities of approximately between 0.25 and 0.30.

Calculating Core Permeability: The permeability, k, of the core is calculated using Darcy's Law:

$$k = \frac{μ LQ}{A Δ P} , \qquad ( Eq . 2 )$$

where A is the cross-sectional area of the core (cm), ΔP is the pressure drop across the core (dynes/cm²), Q is the volumetric flow rate (cm³/s), L is the length of the core (cm), and μ is the viscosity of the brine (poise).

The permeability was calculated from the steady state pressure drop value recorded from the LABView software.

Calculating Apparent Viscosites: The apparent viscosity of the injected fluid (emulsion or nanoparticle dispersion) while flowing through the Boise sandstone core was also calculated using Darcy's law:

$${μ}_{app} = \frac{- kA}{Q} \frac{( {P}_{o} - {P}_{i} )}{L} , \qquad ( Eq . 3 )$$

where k is the permeability of the core (cm²), A is the cross-sectional area of the core (cm), Pₒ and Pᵢ are the outlet pressure and inlet pressure (dynes/cm²), Q is the volumetric flow rate (cm³/s), and L is the length of the bead core (cm).

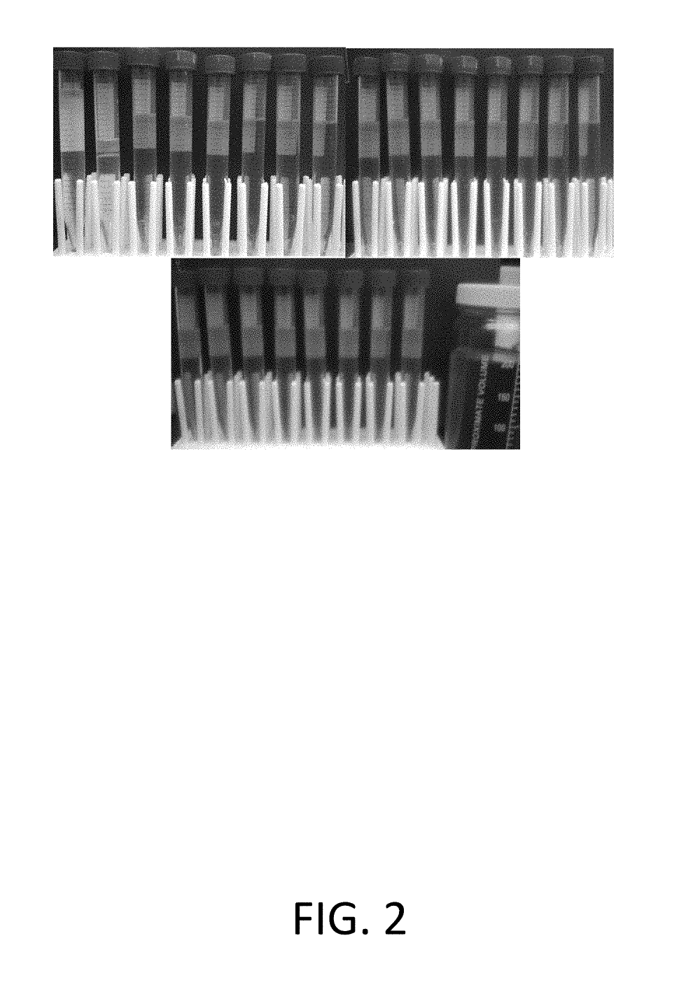

Residual Water Saturation and Residual Oil Saturation: The residual water saturation, S_{wr}, was calculated by counting the amount of brine collected in the effluent which was displaced from the core by injection of the desired organic phase. The equation used is as follows:

$${S}_{wr} = \frac{PV - displaced water during oil injection}{PV} , \qquad ( Eq . 4 )$$

where PV is pore volume. FIG. 2 shows a sample effluent collected from mineral oil injection displacing brine to get to residual water saturation. The mineral oil was dyed red to help distinguish it from the brine. The first few pore volumes were collected in 15 mL centrifugal tubes to accurately estimate the volume of brine displaced and collected. When little to no water was observed, the effluent was collected in bulk in a large container.

The residual oil saturation, Sₒᵣ, was calculated from the amount of organic phase that was collected in the effluent after displacement by brine. It was calculated using the following equation:

$${S}_{or} = \frac{PV ( 1 - {S}_{wr} ) - oil displaced during water flood}{PV} , \qquad ( Eq . 5 )$$

where PV is pore volume.

Brine was injected into the core at incrementally increasing flow rates until no more oil was recovered in the effluent. The core was then considered to be at residual oil saturation.

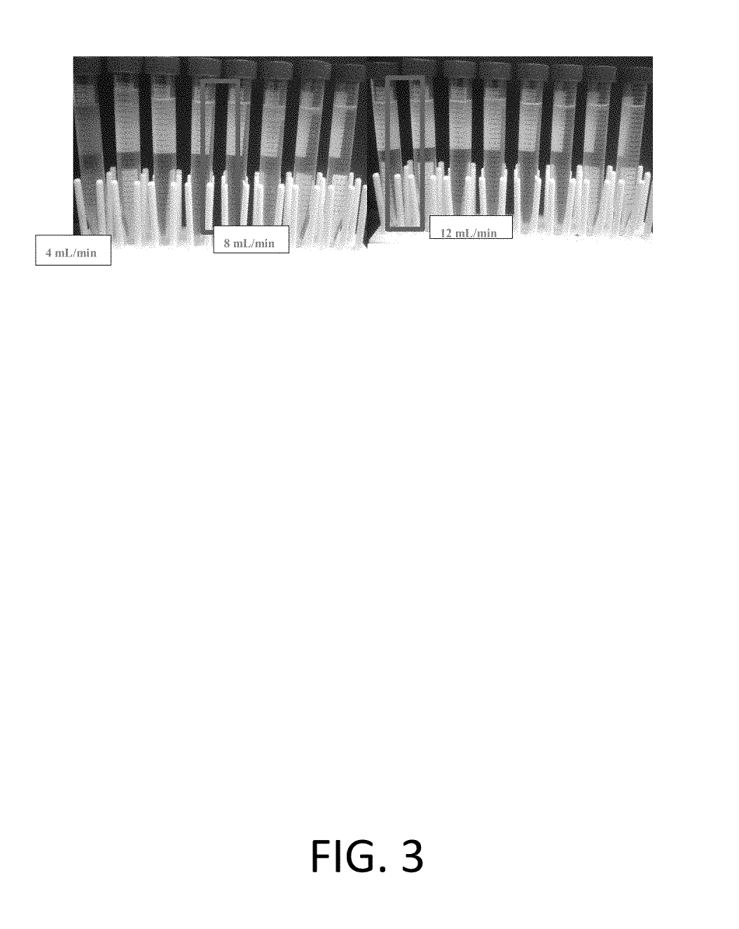

The effluent for the entire waterflood was collected in similar 15 mL centrifugal tubes as in the previous step. A sample effluent collected from a waterflooding experiment is shown in FIG. 3. In FIG. 3, the light brown color can be identified as Texaco oil, which was being displaced by brine. Incremental increase in flow rate shows small amounts of oil displaced at various pore volumes of effluent collected.

### Example 1: Effective Nanoparticle Size Analysis

As the salinity increases, the effective nanoparticle size should also increase due to the reduction in the electrostatic repulsion between negatively-charged silica nanoparticles.

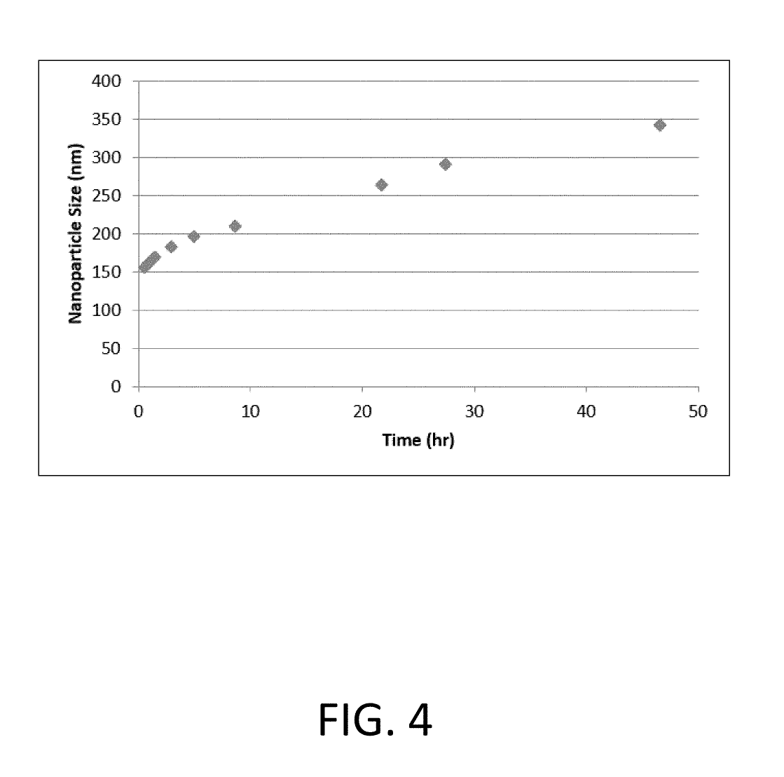

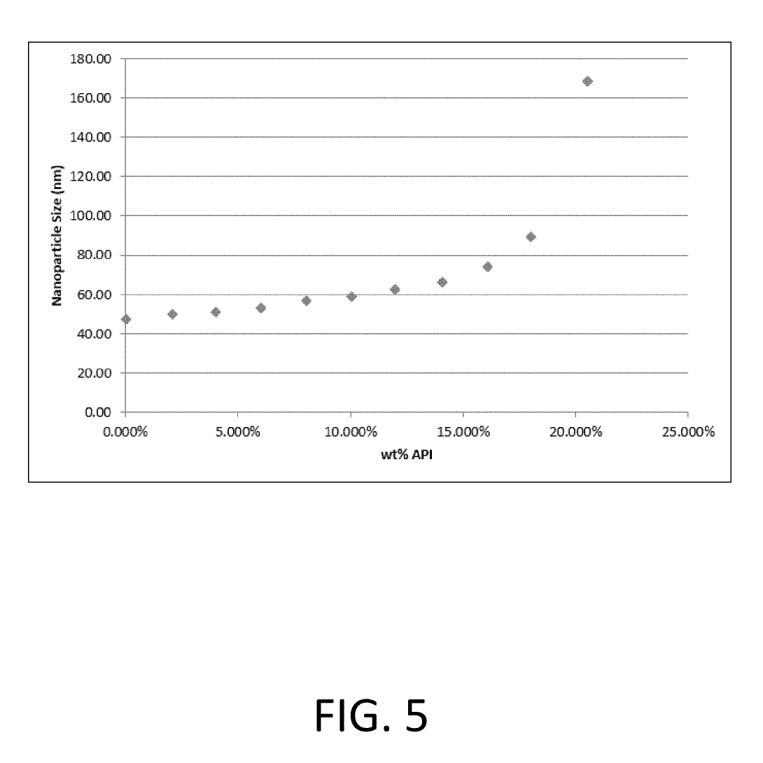

The results for the effects of salinity on the effective nanoparticle size for the NYACOL DP9711™ and PEG-coated nanoparticle dispersions of 2 wt % nanoparticles and 0-20 wt % API brines are shown in Table 1. The transient tests revealed that while the 20 wt % NYACOL DP9711™ dispersion lost its stability with time, all other lower-salinity dispersions showed only minor aggregation behavior for the two-day duration of tests. As time passed, the turbidity of the 20 wt % NYACOL DP9711™ dispersion increased, and after seven days a noticeable sediment began to develop at the bottom of the vial due to particle aggregates precipitating out of the dispersion. The results for the transient test of this particular dispersion are shown in FIG. 4. Table 1 displays the average of the effective nanoparticle sizes from the transient tests for each dispersion, except for the 20 wt % NYACOL DP9711™ dispersion, in which case the initial effective nanoparticle size is displayed. FIG. 5 shows the effective size of the NYACOL DP9711™ nanoparticles as the salinity was varied from 0-20 wt % in increments of 2 wt %, measured immediately after preparation.

TABLE 1

| Effective Nanoparticle | API Brine wt % | | | | |
|---|---|---|---|---|---|
| Size (nm) | 0% | 5% | 10% | 15% | 20% |
| DP9711 | 46 | 51 | 59 | 71 | 155* |
| PEG-coated | 13 | 22 | 26 | 43 | 50 |

*NYACOL DP9711 ™ at 20 wt % API was unstable transiently. Initial size at time of preparation given.

As the salinity of the nanoparticle dispersion increases, there is a noticeable upward trend of nanoparticle size. As the electrolyte concentration increases, the electrostatic repulsion between particles decreases. Aggregation of particles increases as the Brownian motion and the attractive forces between particles becomes greater than the repulsive forces (Azadgoleh, J. E., et al., 2014, “Stability of Silica Nanoparticle Dispersion in Brine Solution: An Experimental Study”. Iranian J Oil & Gas Sci Tech, 3(4):26-40), leading to larger observed effective nanoparticle sizes as salinity increases, as seen in Table 1. Slight changes in turbidity were seen as the salinity was increased for the NYACOL DP9711™ dispersions, but no changes in turbidity were seen in the PEG-coated nanoparticle dispersions. The changes in dispersion turbidity were a result of the aggregation of nanoparticles. The changes in the turbidity of the NYACOL DP9711™ dispersions were more pronounced than the PEG-coated nanoparticle dispersions likely due to the fact that the NYACOL DP9711™ concentrated dispersion has a light blue fluorescent color, while the PEG-coated nanoparticle concentrated dispersion is entirely translucent. This is likely due to the difference in surface coatings. Thus, as the nanoparticles aggregate in each dispersion with increasing salinity, the changes in turbidity in the NYACOL DP9711™ dispersions are more pronounced than in the PEG-coated nanoparticle dispersions.

There are several possible reasons why the NYACOL DP9711™ nanoparticles began to destabilize at 20 wt % and the PEG-coated nanoparticle nanoparticles did not. While not wishing to be bound by theory, reasons could include differences in pH, initial nanoparticle size, and surface coating. Kobayashi et al. (2005, “Aggregation and Charging of Colloidal Silica Particles: Effect of Particle Size”, Langmuir, 21(15):5761-5769) showed that for 30 nm particles, the particles aggregate at higher pH and are completely stable at low pH when salinity is increased. The opposite is true for the dispersions being compared in this example: the concentrated NYACOL DP9711™ dispersion is provided at a pH of 3, while the concentrated PEG-coated nanoparticle dispersion is provided at a pH of 9.65. It should be noted that as the salinity is increased, the pH of the dispersions should trend toward neutral, as is the nature of adding salts to acidic or alkaline solutions. The surface coatings are likely different, but are incomparable due to NYACOL DP9711™ coating.

### Example 2: Effect of Salinity on Pentane Emulsion Droplet Size

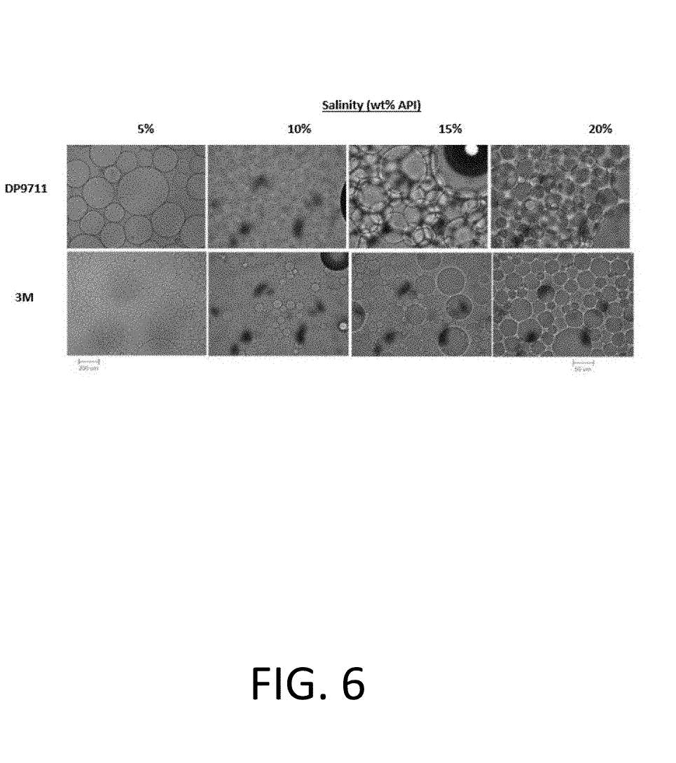

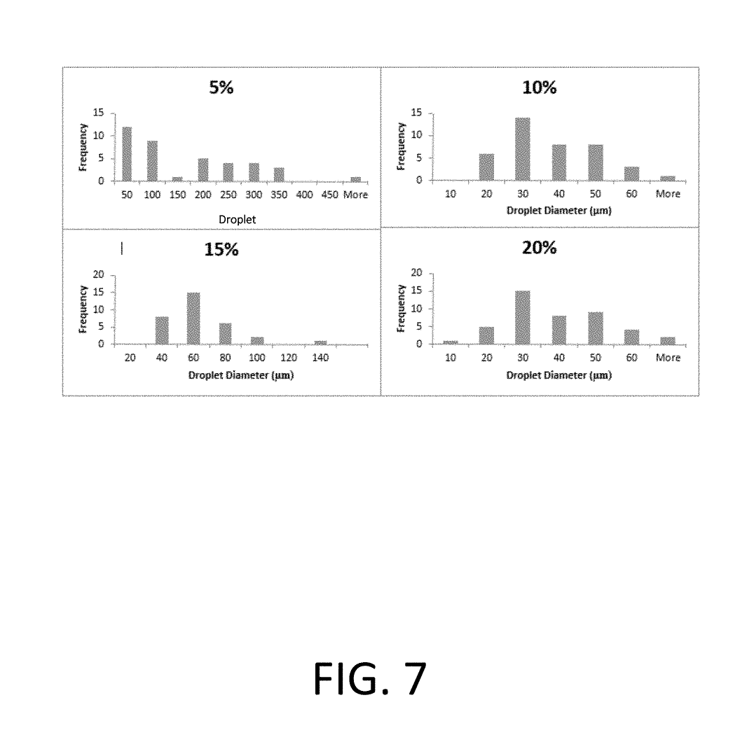

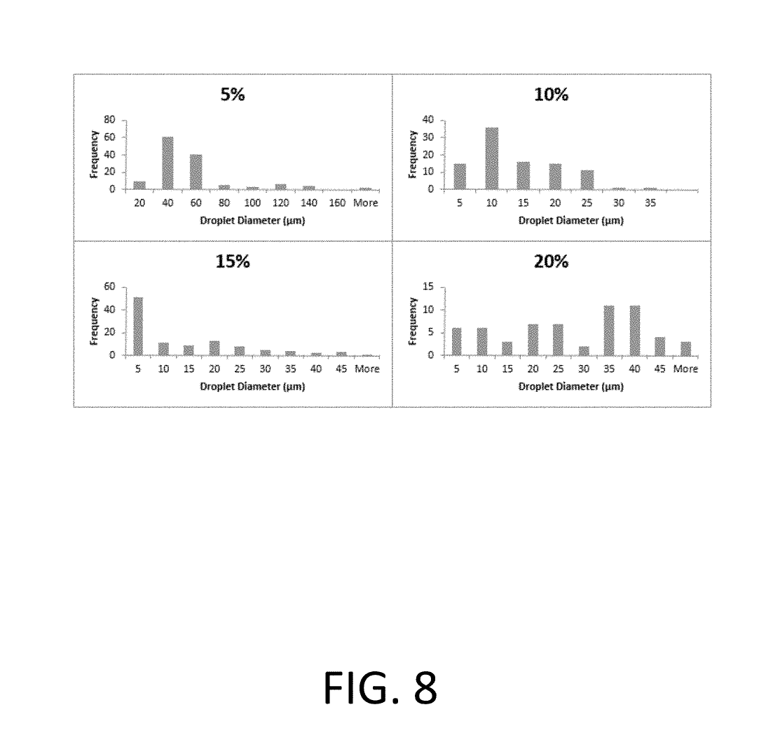

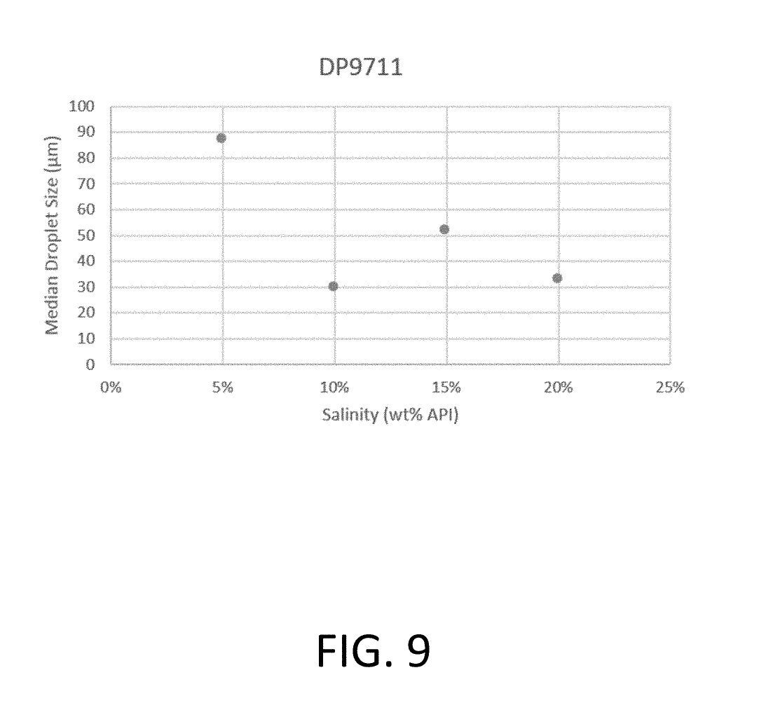

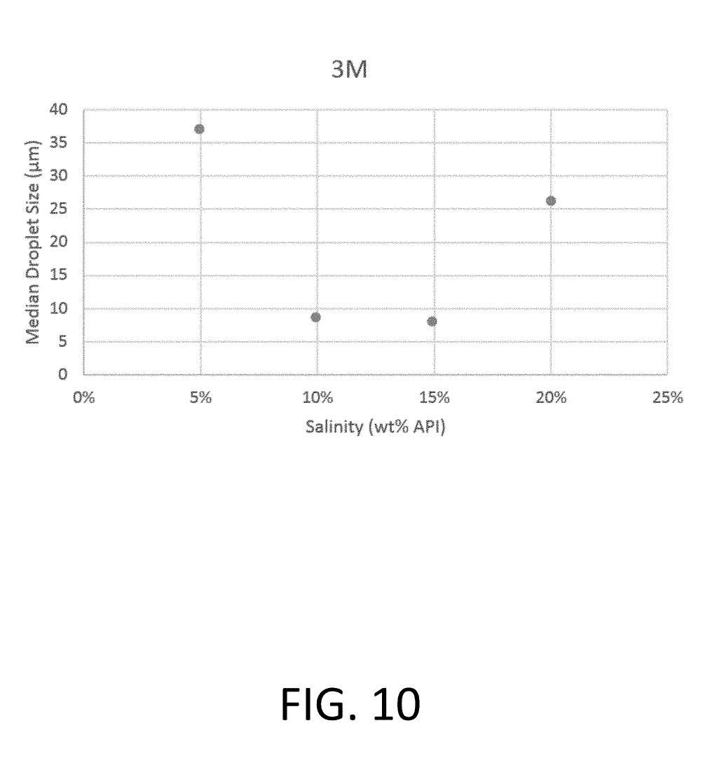

Pentane emulsions were generated using the NYACOL DP9711™ and PEG-coated nanoparticle nanoparticle dispersions, each at 2 wt % in their respective aqueous phases. Droplet images for each emulsion are shown in FIG. 6. The droplet size distributions for the emulsions obtained using ImageJ are displayed in FIGS. 7 and 8. Finally, the median droplet sizes values are plotted against their corresponding API brine concentrations in FIGS. 9 and 10. The median droplet size was used to quantify the overall droplet size of each emulsion because some emulsion images had one or two droplets that were much larger than the others, thus skewing the value of the mean droplet size.

A significant decrease in median droplet size was observed for both emulsions when the salinity was increased from 5 wt % to 10 wt % as shown in FIGS. 9 and 10. The NYACOL DP9711™ emulsion experienced a decrease of 65%, while the PEG-coated nanoparticle emulsion experienced a decrease of 75%. However, as the salinity further increases, less recognizable trends were apparent. Comparing the NYACOL DP9711™ and PEG-coated nanoparticle emulsions, the median droplet sizes for the PEG-coated nanoparticle emulsions are smaller for all ranges of salinity. This may imply the relationship that as the effective nanoparticle size decreases the emulsion droplet size decreases as well (Kim, I., et al., 2015, “Aggregation of Silica Nanoparticles and its Impact on Particle Mobility under High-Salinity Conditions.” J Petroleum Sci. Eng., 133(1):376-383). The PEG-coated nanoparticle dispersions had roughly half the effective particle size of the NYACOL DP9711™ dispersions for each salinity. However, assessing each type of emulsion exclusively, as the effective nanoparticle size increases with the increase in salinity from 10 wt % to 20 wt %, there are no distinct trends in droplet size. This implies that the effective size of the nanoparticles is not the only factor influencing the droplet size, especially at higher concentrations of salinity. Gabel (2014) and Zhang (2010) showed that with increasing shear rate through the beadpack and increasing nanoparticle concentration, emulsion droplet size decreased, respectively. However, in this study these factors were held constant. Other factors may include the surface coating of the nanoparticles and the effect of the formation of a three-dimensional network of interconnected droplets and aggregates proposed by Horozov et al. (2007). In fact, at salinities greater than 10 wt % these indefinite trends in droplet size are likely dependent on a combination of interdependent factors that include but are not limited to: pH, particle size, droplet coverage, surface coating of the nanoparticles, and the extent of the three-dimensional droplet-aggregate network.

### Example 3: Effects of Salinity on Pentane Emulsion pH

Table 2 shows the pH values of the nanoparticle dispersions for the PEG-coated and DP9711 dispersions. There was no change in pH in the emulsion phase when compared to the dispersion's pH values. This is likely an artifact of the way the pH is measured via a pH probe. When inserted into the emulsion the probe does not break the emulsion droplets, thus measuring the pH of the aqueous nanoparticle dispersion medium of the emulsion. As the salinity of each dispersion increases, the pH of the dispersion becomes more neutral as is expected. There is no noticeable trend between pH and droplet size.

TABLE 2

| Salinity (wt % API) | pH (NYACOL DP9711 ™) | pH (PEG-coated) |
|---|---|---|
| 5% | 8.803 | 5.571 |
| 10% | 8.725 | 6.634 |
| 15% | 8.695 | 7.116 |
| 20% | 8.567 | 7.562 |

### Example 4: Effects of Salinity on Pentane Emulsion Stability

As for stability, all emulsions remained stable if kept pressurized in an accumulator at 100 psi. Due to the volatility of pentane, the emulsions would coalesce and destabilize if kept at atmospheric pressure. The pentane emulsions made with the NYACOL DP9711™ nanoparticles with salinities ranging from 5-15 wt % API brine destabilized relatively quickly—within two hours of generation at atmospheric pressure. The emulsion generated at 20 wt % API brine formed a gel-like substance after one day and remained in that state indefinitely. No droplets were visible under a microscope after one day, yet the gel was opaque and much more viscous than the nanoparticle dispersion phase.

The PEG-coated nanoparticle emulsions were more stable at atmospheric pressure. The 5 wt % API brine emulsion was stable for approximately 2 days (˜48 hours), while the 10 wt % and 15 wt % API brine emulsions were stable for approximately 1 day (˜24 hours). The 20 wt % API brine emulsion formed a gel after 1 day and remained in that state indefinitely, like the DP9711 emulsion at 20 wt % API brine. Again, no droplets were visible under the microscope after one day.

The occurrence of gel formation, instead of droplet coalescence and separation into two phases (nanoparticle dispersion and oil phase), for the emulsions generated at 20 wt % was likely due to the following (without being wed to any particular theory). Because of the high electrolyte concentration in the aqueous dispersion phase, the nanoparticles tend to aggregate and form nanoparticles of larger effective size. In the NYACOL DP9711™ dispersion the effective size of the nanoparticles was shown to increase over time, while the effective size of the PEG-coated nanoparticles remained constant. However, further agitation by flow through the beadpack may have an effect on the previously observed stability of the PEG-coated effective nanoparticle size, resulting in increased aggregation. As the emulsion droplets coalesce, some of the pentane may become trapped in a gel-like substance comprising a dense matrix of highly-aggregated nanoparticles and high-salinity water. This semi-continuous pentane, no longer in droplet form, rises slowly to the top of this gel and evaporates, leaving a denser, more viscous gel-like substance behind. Approximately a day after emulsion generation, this gel likely consists of highly aggregated nanoparticles, high-salinity water, and residual amounts of trapped pentane no longer in droplet form.

The formation of more stable emulsions from using the PEG-coated nanoparticle dispersions could be due to a handful of factors. Overall smaller droplets, different surface coatings, and smaller effective nanoparticle size may comparatively increase the stability of the emulsions.

### Example 5: Effects of Salinity on Pentane Emulsion Rheology

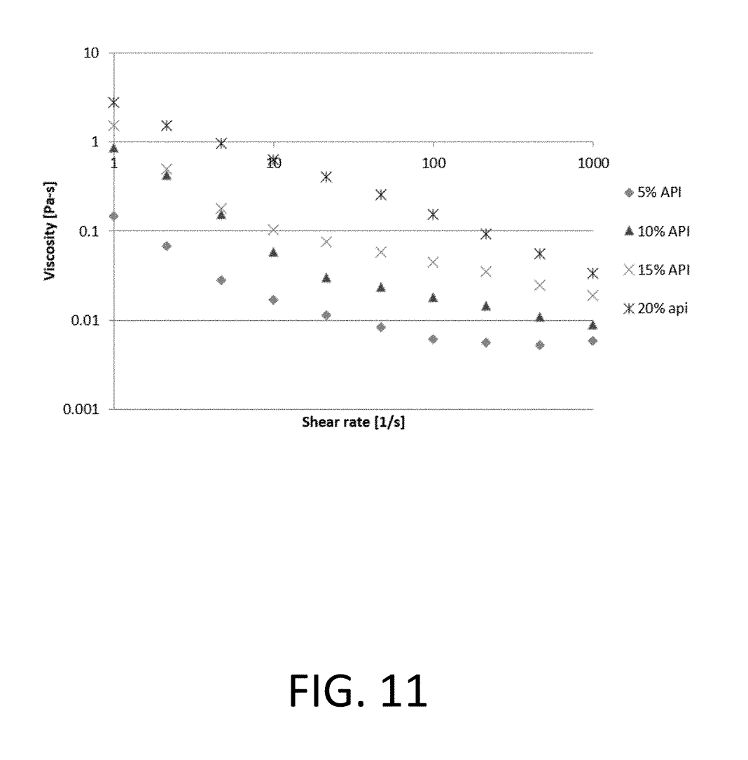

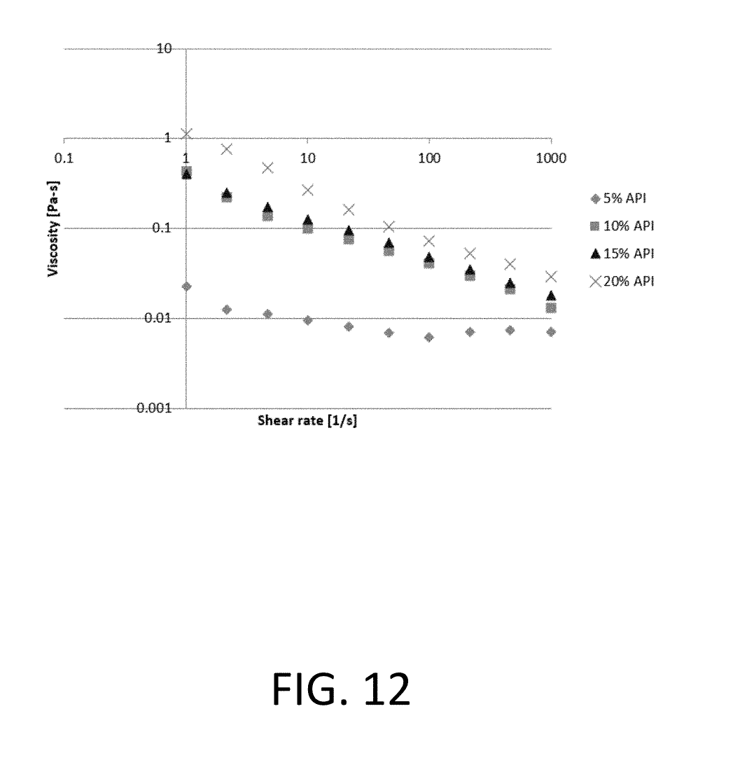

Rheology measurements were made within ten minutes of emulsion generation for the emulsions generated using the NYACOL DP9711™ and PEG-coated nanoparticle dispersions at salinities varying from 5-20 wt %. The effective viscosity of the emulsions as the shear rate was varied from 1 to 1000 1/s is shown in FIGS. 11 and 12. These emulsions were found to be highly shear-thinning fluids, which can be represented by the power-law model:

τ=K\dot{γ}ⁿ (Eq. 6)

where τ is the shear stress, K is the consistency index, \dot{γ} is the shear rate, and n is the flow behavior index. The power-law model values for each emulsion are shown in Tables 3 and 4, along with the corresponding R² values.

TABLE 3*

| Salinity (wt % API) | K (cp-sⁿ) | n | R² |
|---|---|---|---|
| 5% | 0.07 | −0.461 | 0.8522 |
| 10% | 0.4541 | −0.650 | 0.905 |
| 15% | 0.6634 | −0.566 | 0.9029 |
| 20% | 2.6944 | −0.626 | 0.9987 |

*for pentane emulsions generated with DP9711 nanoparticle dispersions

TABLE 4*

| Salinity (wt % API) | K (cp-sⁿ) | n | R2 |
|---|---|---|---|
| 5% | 1.0192 | −0.545 | 0.9888 |
| 10% | 0.3664 | −0.438 | 0.998 |
| 15% | 0.3318 | −0.459 | 0.9852 |
| 20% | 0.0147 | −0.137 | 0.6688 |

*for pentane emulsions generated with PEG-coated nanoparticle dispersions

As the salinity is increased, the effective emulsion viscosity also increases for both types of emulsions. The emulsions generated using the NYACOL DP9711™ nanoparticle dispersions are characterized as having higher viscosities than those using the PEG-coated nanoparticle dispersions. Gabel (2014) found that the effective viscosity of an emulsion increased as the droplet size decreased. It appears that this hypothesis cannot be applied to comparing the viscosities of emulsions created with two similar but different nanoparticle dispersions—considering the fact that the droplet sizes for the PEG-coated nanoparticle emulsions were smaller. The differences in viscosity may be a result of differences in pH of the aqueous phase, surface coating of the nanoparticles, or droplet particle coverage. These factors could affect the overall droplet composition and how the droplets interact with each other (i.e., the composition of the droplet-aggregate network).

The effects of salinity on droplet sizes are shown in FIGS. 7-10. FIGS. 7 and 8 are histogram distributions of droplet sizes as a function of salinity, for NYACOL DP9711™ and PEG-coated nanoparticle emulsions respectively. FIGS. 9 and 10 give the median droplet size as a function of salinity for NYACOL DP9711™ and PEG-coated nanoparticle emulsions, respectively. As seen in FIGS. 7 and 9, there is a large decrease in median droplet size as the salinity is increased from 5 wt % to 10 wt %. This corresponds to a large jump in effective viscosity as seen in FIG. 12. Only a slight increase in effective viscosity is seen as the salinity is increased from 10 wt % to 15 wt %. This corresponds to a very slight decrease in droplet size. As the salinity is increased to 20 wt %, the droplet size increases, while a substantial increase is seen in the effective viscosity. As discussed herein, this increase in viscosity may be due to the formation of a strong network of interconnected droplets and aggregates. The transient formation of such droplet-aggregate networks should not be disregarded when considering the increases seen in emulsion viscosity at salinities less than 20 wt %.

Analysis of the effects of salinity on the viscosity of the NYACOL DP9711™ emulsions is not so clear, but the discussion on the PEG-coated nanoparticle emulsions may assist in explaining the fundamentals of what is happening. Effects of salinity on the droplet size for the PEG-coated nanoparticle emulsions are shown in FIGS. 8 and 10. Like the PEG-coated nanoparticle emulsions, there is a large decrease in the NYACOL DP9711™ droplet size as the salinity is increased from 5 wt % to 10 wt % for the NYACOL DP9711™ emulsion, corresponding to a relatively moderate increase in viscosity. However, as the salinity is increased from 10 wt % to 15 wt % there is an increase in droplet size and an increase in viscosity. The formation of the droplet-aggregate network may have a greater effect on the viscosity of the NYACOL DP9711™ emulsions than the PEG-coated nanoparticle emulsions. Finally, as the salinity is increased from 15 wt % to 20 wt % there is a decrease in droplet size, and another subsequent increase in apparent viscosity for the DP9711 emulsion.

In summary, it was found that as the salinity of the emulsion increases, viscosity also increases. This can be attributed to the initial decrease in droplet size and the formation of a three-dimensional network of interconnected droplets and aggregates. Thus, at lower salinities (<10 wt %) the droplet size has a more significant effect on the characteristics of the emulsion viscosity. However, as the salinity increases above a certain threshold value, the droplet size seems to have less influence on emulsion viscosity and the increasing formation of a droplet-aggregate network tends to dominate the apparent viscosity increase.

### Example 6: Effects of Salinity on Butane Emulsion Characteristics

To maintain its stability, the effluent emulsion from the 180 micron glass bead beadpack needed to be kept under pressure (approximately 100 psi) to keep the liquid n-butane in the emulsion from evaporating. A viewing cell was therefore created to quantify the effects of salinity on the overall emulsion composition. While rheological measurements were not feasible due to the volatile nature of butane, quantifications regarding the fraction of emulsion produced in the effluent, overall emulsion stability, and qualitative comparisons of viscosity could be made.

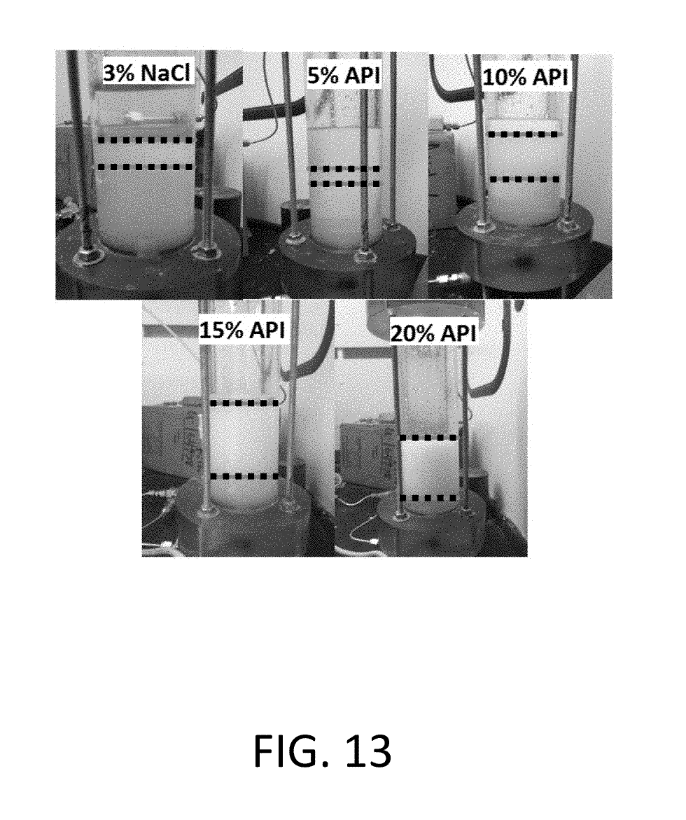

Using the NYACOL DP9711™ nanoparticle dispersion (3 wt % sodium chloride, no calcium chloride) that is used in the pentane emulsion coreflood examples below, a butane-in-water emulsion was generated, as pictured in FIG. 13. The effluent from the beadpack had a very small fraction of emulsion phase. The emulsion phase coalesced completely within five minutes while under pressure. Compared to the other emulsions, this appeared the least viscous.

As the salinity was increased for the other emulsions (5 wt % through 20 wt % API ratio brine), an increasing fraction of emulsion phase was observed. Images of the emulsions created using API brines can be observed in FIG. 13. Note that the emulsion phase is the opaque, white phase between the clear liquid butane phase on top and the slightly translucent aqueous nanoparticle dispersion below. Also, as the salinity of the dispersions increased, the time to complete coalescence increased as well. In other words, increasing salinity resulted in increased emulsion stability. Lastly, by observing the flow into the view cell it was apparent that with increasing salinity, the viscosity of the emulsion appeared to increase. While there was no way to accurately quantify the differences in viscosity between emulsions, there was a significant qualitative increase observed based on appearance. This agrees with the rheological results from the pentane emulsions. As the salinity is increased, the increasing fraction of emulsion phase can be contributed to increasing emulsion stability brought about by the growth of the formation of the three-dimensional network of interconnected droplets and aggregates.

In Examples 7-10, pentane emulsions were injected into sandstone cores at residual oil saturation with the resident oil being light mineral oil. A pentane-in-water emulsion that was stabilized with NYACOL DP9711™ nanoparticles (2 wt % in dispersion) and 3 wt % NaCl was first generated by co-injection into a beadpack with 180 μm hydrophilic glass beads, at a 1:2 volume ratio of pentane to nanoparticle dispersion for a total flow rate of 24 mL/min. To keep the emulsion stable, it was stored in an accumulator pressurized to 100 psi. The effluent from the core holder was collected in a fraction collector and the pressure drop across the core was recorded continuously. The mineral oil was dyed red to distinguish how much residual mineral oil was recovered from the coreflood. Tests were also conducted where a half pore volume of the core (0.5 PV slug) was injected with emulsion and then was driven by a post brine flush. The pentane emulsion has an apparent viscosity of less than 1 centipose. A Beckman-Coulter Laser Diffraction Particle Size Analyzer was used to determine the droplet size of the pentane-in-water nanoparticle stabilized emulsion. The emulsion had a particle diameter of 69.5 μm.

Table 5 summarizes the coreflood experiments described in Examples 7-10. In Table 5, SS is sandstone, φ is porosity of the sandstone, and k is permeability of the sandstone.

TABLE 5

| | | | | | | Flow | |
|---|---|---|---|---|---|---|---|
| | | | k | Initial | Injected | Rate | Recovery |
| Experiment Type | SS | φ | (mD) | Saturation | Fluids | (mL/min) | (%) |
| Mineral Oil | Boise | 0.28 | 3225 | Residual | Pentane | 4 | 69 |
| Residual Oil | | | | Mineral | Emulsion | | |
| Recovery using P- | | | | Oil and | (NP) | | |
| NP Emulsion | | | | Brine | | | |
| Mineral Oil | Boise | 0.28 | 3225 | Residual | Pentane | 1 | 81 |
| Residual Oil | | | | Mineral | Emulsion | | |
| Recovery using P- | | | | Oil and | (NP) | | |
| NP Emulsion | | | | Brine | | | |
| Mineral Oil | Boise | 0.28 | 1690 | Residual | Pentane | 4 | 82 |
| Residual Oil | | | | Mineral | Emulsion | | |
| Recovery using P- | | | | Oil and | (NP) and | | |
| NP Emulsion 0.50 | | | | Brine | Brine | | |
| PV Slug | | | | | | | |
| Mineral Oil | Boise | 0.28 | 1690 | Residual | Pentane | 1 | 57 |
| Residual Oil | | | | Mineral | Emulsion | | |
| Recovery using P- | | | | Oil and | (NP) and | | |
| NP Emulsion 0.50 | | | | Brine | Brine | | |
| PV Slug | | | | | | | |

### Example 7: Mineral Oil Residual Oil Recovery Using P-NP Emulsion at 4 mL/min

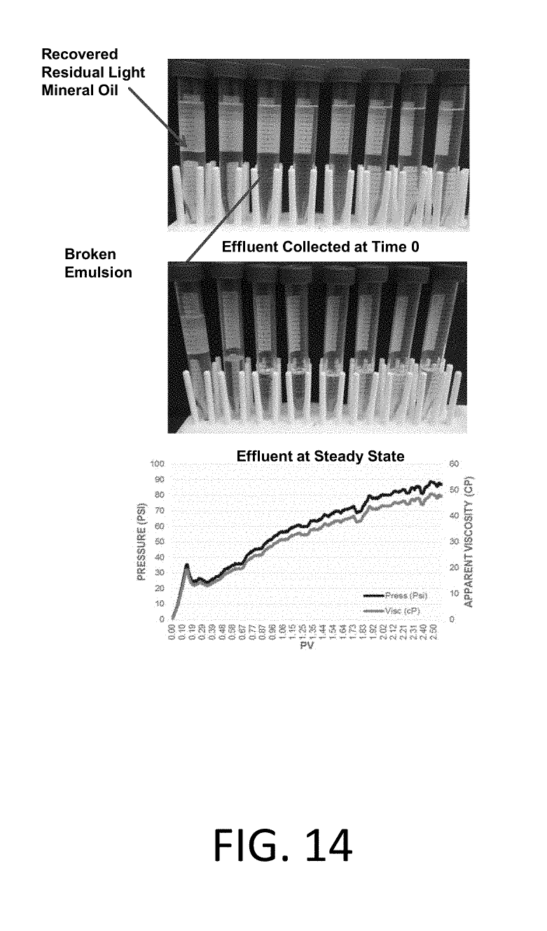

FIG. 14 shows the experimental conditions, a series of effluents at 0.25 PV (pore volume) increments per vial, pressure drop across the core, and the in-situ apparent viscosity (calculated from the pressure data using Darcy's law). This experiment had a flow rate of 4 mL/min. The pentane-in-water emulsion was continuously injected into the sandstone core until no more light mineral oil was seen to be recovered. The pressure drop recorded was seen to increase throughout the duration of the experiment. No stable emulsion was regenerated from the core as expected, because pentane emulsions using the NYACOL DP9711™ nanoparticles were seen to be unstable under room temperature and atmospheric pressure (the effluent tubes being exposed to such conditions). The injected emulsion droplets likely coalesce upon contacting the residual mineral oil in the core, becoming miscible with the residual mineral oil in the core. This can be seen from the shade of the dye in the effluent. Test tube 1 shows the darkest pink, which would suggest the most amount of mineral oil recovered. To assess the amount of recovery of the residual mineral oil, the effluent test tubes were placed under the fume hood and the pentane was allowed to evaporate from the samples.

When the pentane emulsion was injected, the sandstone core was at an initial saturation of brine and residual oil saturation. The residual oil saturation, Sor, was computed to be 0.33 which at a pore volume of 43.70 mL would suggest 14.5 mL of light mineral oil available for recovery. The estimated oil recovery based on the effluent at steady state after pentane was allowed to evaporate was approximately 10 mL of mineral oil. This led to a residual oil recovery of about 69%. Given the viscosity difference between pentane and mineral oil, this is an encouraging recovery number. It may be that because the pentane-in-water emulsion does not stay quite stable inside the core, it may allow for more miscibility between the continuous and resident oils thereby leading to a larger potential oil bank.

Example 7

| k | | Pore Volume | | Flow Rate | Percentage |
|---|---|---|---|---|---|
| (mD) | φ | (mL) | Sor | (mL/min) | Recovery (%) |
| 3225 | 0.28 | 43.70 | 0.33 | 4 | 69 |

### Example 8: Mineral Oil Residual Oil Recovery Using P-NP Emulsion at 1 mL/min

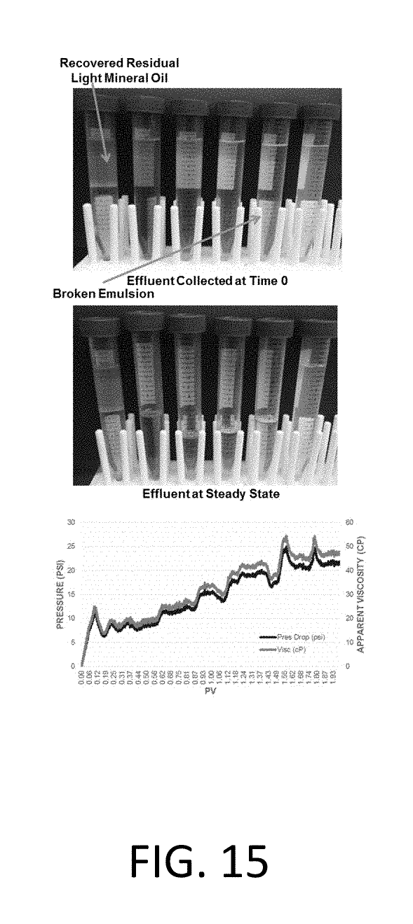

Example 8 had similar conditions to that of Example 7, with the only change being the reduced flow rate. The residual oil saturation, Sor, was computed to be 0.31 which at a pore volume of 43.70 mL would suggest 13.5 mL of light mineral oil available for recovery. The estimated oil recovery based on the effluent at steady state after pentane was allowed to evaporate was approximately 11 mL of mineral oil. This led to a residual oil recovery of about 81%. This number was not expected to be greater than that of 69% recovery at a higher flow rate but is an interesting observation. Normally higher flow rates lead to lower recoveries due to smaller durations for coalescence and regeneration and miscibility in the core. Without being wed to theory, this increase in recovery could be due to the fact that the emulsion spends a longer duration in the core, allowing for more extensive coalescence and regeneration of emulsion, further increasing the displacing front's miscibility. The expected phenomena of constant coalescence and regeneration is reflected in the ever-increasing pressure drop measurements seen both in FIGS. 14 and 15. No emulsion was regenerated in the effluent, which is to be expected due to the volatility of pentane at room temperature and pressure. The results can be seen in FIG. 15.

Example 8

| k | | Pore Volume | | Flow Rate | Percentage |
|---|---|---|---|---|---|
| (mD) | φ | (mL) | Sor | (mL/min) | Recovery (%) |
| 3225 | 0.28 | 43.70 | 0.31 | 1 | 81 |

### Example 9: Mineral Oil Residual Oil Recovery Using P-NP Emulsion 0.50 PV Slug at 4 mL/min

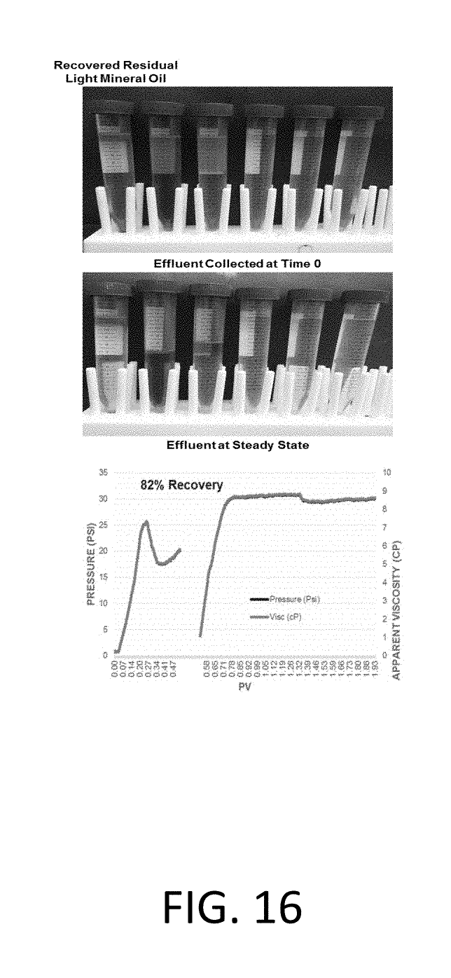

FIG. 16 shows the experimental conditions, effluent of emulsion injection into the core, pressure drop and apparent viscosity for Example 9. This experiment had a flow rate of 4 mL/min. A 0.50 core pore volume (PV) of pentane emulsion (0.5 PV slug) was injected into the core, followed by a post-brine flush. The post-brine flush was performed until no more light mineral oil was seen to be recovered. All displacing fluids were injected into the core at 4 mL/min. The pressure drop was seen to increase throughout the duration of the emulsion injection and was seen to stabilize during the post-brine flush. This stabilization of the pressure drop indicates a cease in the coalescence and regeneration of emulsion. No emulsion was regenerated from the core which would be expected as there is a limited amount of emulsion injected. The injected pentane emulsion was seen to completely coalesce, leading to miscibility with the residual resident mineral oil present in the core. This can be seen from the shade of the dye in the effluent shown in FIG. 16. Test tube 2 shows the darkest red, which would suggest the most amount of mineral oil recovered. To assess the amount of recovery of the residual mineral oil, the effluent test tubes were placed under the fume hood and the pentane was allowed to evaporate from the samples.

When the pentane emulsion was injected, the sandstone core was at an initial saturation of brine and residual oil saturation. The residual oil saturation, Sor, was computed to be 0.25 which at a pore volume of 44.40 mL would suggest 11.0 mL of light mineral oil available for recovery. The estimated oil recovery based on the effluent at steady state after pentane was allowed to evaporate was approximately 9 mL of mineral oil. This led to a residual oil recovery of about 82%.

Example 9

| k | | Pore Volume | | Flow Rate | Percentage |
|---|---|---|---|---|---|
| (mD) | φ | (mL) | Sor | (mL/min) | Recovery (%) |
| 1690 | 0.28 | 44.40 | 0.25 | 4 | 82 |

### Example 10: Mineral Oil Residual Oil Recovery Using P-NP Emulsion 0.50 PV Slug at 1 mL/min

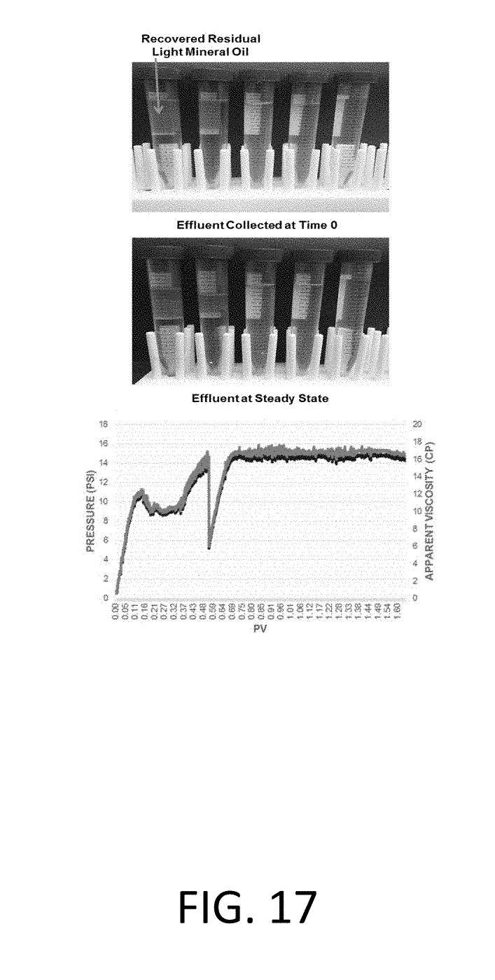

Example 10 had similar conditions to that of Example 9, with the only change being the flow rate was reduced to 1 mL/min. The residual oil saturation, Sor, was computed to be 0.26 which at a pore volume of 44.40 mL would suggest 11.5 mL of light mineral oil available for recovery. The estimated oil recovery based on the effluent at steady state after pentane was allowed to evaporate was approximately 6.5 mL of mineral oil. This led to a residual oil recovery of about 57%. No emulsion was regenerated. The results are shown in FIG. 17.

The pressure drop was very similar to the one observed in Example 9. In this case, reducing the flow rate had a negative effect on the amount of residual oil recovered. Without being wed to theory, the difference in the effect of reducing flow rates is likely a result of the cease in coalescence and regeneration of the emulsion during the post-brine flush. In the case of injecting a 0.5 PV slug, at low flow rates the emulsion may begin to completely coalesce and separate (reducing the chances of regeneration) when the post-brine flush commences, leading to a less continuous displacing front resulting in less residual oil recovery. However, when the emulsion is being continuously injected into the core there is less chance of phase separation at low flow rates, leading to more extensive emulsion coalescence and regeneration increasing the amount oil recovered.

Example 10

| k | | Pore Volume | | Flow Rate | Percentage |
|---|---|---|---|---|---|
| (mD) | φ | (mL) | Sor | (mL/min) | Recovery (%) |
| 1690 | 0.28 | 44.40 | 0.26 | 1 | 57 |

As the salinity was increased from 0-20 wt % for the NYACOL DP9711™ and the PEG-coated nanoparticle dispersions a noticeable increasing trend in effective nanoparticle size was observed. Such increase in nanoparticle aggregation can be explained by the decrease in electrostatic repulsion between particles with increasing salinity.

A significant decrease in median droplet size was observed for the pentane-in-water emulsions when the salinity was increased from 5 wt % to 10 wt %, however less distinct trends were observed for salinities greater than 10 wt %. For all salinities (5-20 wt %), pentane emulsions were shown to remain stable if pressurized at 100 psi. When kept at room temperature and pressure, the emulsions would destabilize within 2 days, except for the emulsions at 20 wt % salinity due to the formation of a gel-like substance comprising nanoparticle aggregates, high-salinity water, and residual amounts of trapped pentane. Pentane emulsion rheology was observed to be strongly shear-thinning. As the salinity of the emulsions increased, an increase in effective viscosity was observed.

Butane emulsions were generated using nanoparticle dispersions ranging from 5-20 wt % salinity. As the salinity was increased, an increase in fraction of emulsion phase and viscosity was observed.

Residual oil recovery coreflood experiments were conducted using Boise Sandstone cores, light mineral oil as the residual oil phase, and pentane emulsions as the displacing phase. It was shown that with continuous-injection pentane coreflood experiments, decreasing the flow rate led to increases in residual oil recovery. This increase in recovery may be due to the extension in the amount of time that the emulsion is in contact with the residual mineral oil, further increasing the displacing front's miscibility as the emulsion coalesces. For coreflood experiments using a 0.50 PV injection of pentane emulsion followed by a post-brine flush, increases in recovery were observed at higher flow rates. In this case, it was proposed that at low flow rates the 0.50 PV slug of emulsion began to completely coalesce and separate (reducing the chances of regeneration) during the post-brine flush, leading to a less continuous displacing front resulting in less residual oil recovery.

Recoveries of 81% and 82% were observed for the continuous-injection and 0.50 PV pentane emulsion coreflood tests, respectively. These coreflood tests show the potential that nanoparticle-stabilized natural gas liquid emulsions possess in the recovery of heavier, more viscous residual oil phases. Finally, when compared to conventional emulsion-stabilizing materials such as surfactants, nanoparticles offer an inexpensive and robust alternative with stability over a wider range of temperature and salinity, while reducing environmental impact.

The methods and compositions of the appended claims are not limited in scope by the specific methods and compositions described herein, which are intended as illustrations of a few aspects of the claims and any methods and compositions that are functionally equivalent are within the scope of this disclosure. Various modifications of the methods and compositions in addition to those shown and described herein are intended to fall within the scope of the appended claims. Further, while only certain representative methods, compositions, and aspects of these methods and compositions are specifically described, other methods and compositions and combinations of various features of the methods and compositions are intended to fall within the scope of the appended claims, even if not specifically recited. Thus a combination of steps, elements, components, or constituents can be explicitly mentioned herein; however, all other combinations of steps, elements, components, and constituents are included, even though not explicitly stated.

What is claimed is:

1. An emulsion for recovery of residual heavy oil from a porous structure, the emulsion comprising;
an aqueous continuous phase,
an organic dispersed phase comprising an organic compound having five or fewer carbon atoms, and
nanoparticles comprising a hydrophilic exterior surface,
wherein the nanoparticles make up at least 0.1% of the emulsion by weight.

2. The emulsion of claim 1, wherein the emulsion does not comprise surfactants.

3. The emulsion of claim 1, wherein the organic compound is pentane or butane.

4. The emulsion of claim 1, wherein the apparent viscosity of the emulsion is less than or equal to 1 centipoise.

5. The emulsion of claim 1, wherein the nanoparticles measure from 5 to 25 nanometers across at their widest point.

6. The emulsion of claim 1, wherein the volume ratio of the aqueous phase to organic phase is from 0.5:1 to 4:1.

7. The emulsion of claim 6, wherein the nanoparticles make up at least 0.25% by weight of the total emulsion.

8. The emulsion of claim 6, wherein the nanoparticles make up at least 0.12% by weight of the total emulsion

9. The emulsion of claim 1, wherein the dispersed organic phase comprises droplets ranging from 20 to 100 μm in diameter.

10. The emulsion of claim 1, wherein the nanoparticles are silica nanoparticles comprising a hydrophilic coating.

11. The emulsion of claim 1, wherein the aqueous phase comprises salinated water or seawater.

12. The emulsion of claim 11, wherein the water comprises from 3 to 20% NaCl by weight.

13. The emulsion of claim 12, wherein the water further comprises CaCl₂.

14. A method of recovering residual heavy oil from a porous structure, the method comprising;
contacting the porous structure with an emulsion, the emulsion comprising;
an aqueous continuous phase,
an organic dispersed phase comprising an organic compound having five or fewer carbon atoms, and
nanoparticles comprising a hydrophilic exterior surface,
the method further comprising recovering at least 55% of the residual heavy oil from the porous structure.

15. The method of claim 14, wherein the aqueous continuous phase comprises salinated water or seawater.

16. The method of claim 14, further comprising recovering at least 65% of the residual oil from the porous structure.

17. The method of claim 14, further comprising moving the emulsion through the porous structure at a flow rate of less than or equal to 12 mL/min.

18. The method of claim 14, wherein the ratio of the volume of the emulsion moved through the porous structure to the pore volume of the porous structure (PV) is 0.75 or less.

19. The method of claim 14, further comprising flushing the porous structure with water after contacting the porous structure with the emulsion.

20. The method of claim 14, further comprising maintaining the emulsion at a pressure of at least 100 PSI.
